(19) United States
(12) Patent Application Publication
(10) Pub. No.: US 2006/0196973 A1
(43) Pub. Date: Sep. 7, 2006

(54) Fuel injection valve for internal combustion engines

(76) Inventors: Thomas Kuegler, Korntal-Muenchingen (DE); Jochen Mertens, Reutlingen (DE); Hasiman Uskudar, Nilufer/Bursa (TR)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/547,773

(22) PCT Filed: Oct. 6, 2003
(86) PCT No.: PCT/DE03/03304

§ 371 Date: Sep. 2, 2005

(30) Foreign Application Priority Data
Mar. 21, 2003 (DE) 103 12 586.8

(51) Int. Cl. F02M 63/00

(52) U.S. Cl. 239/533.2

(57) ABSTRACT

A fuel injection valve, having a valve body that contains a bore whose combustion chamber end is delimited by a valve seat from which at least two injection openings lead. The bore contains outer and inner concentric valve needles whose ends oriented toward the combustion chamber each open and close the injection openings. A pressure chamber between the outer valve needle and the valve body bore can be filled with fuel. The inner valve needle is guided in a longitudinal bore of the outer needle by first and second sections between which an annular chamber is formed, which is delimited by the inner valve needle and the wall of the longitudinal bore. A throttle connection is capable of connecting the annular chamber to the pressure chamber and the diameter of the first guide section is greater than the diameter of the second guide section.

### PRIOR ART

The invention is based on a fuel injection valve for internal combustion engines of the kind known from DE 30 36 583 A1. A fuel injection valve of this kind has a valve body in which a bore is provided. At its combustion chamber end, the bore is delimited by a valve seat that has a number of injection openings leading from it, which are arranged in an outer row and an inner row of injection openings; in the installed position of the fuel injection valve in an internal combustion engine, the injection openings feed into the combustion chamber. The bore in the valve body contains a longitudinally sliding outer valve needle whose end oriented away from the combustion chamber is guided in the bore. Between the outer valve needle and the wall of the bore, there is a pressure chamber that can be filled with pressurized fuel. The combustion chamber end of the outer valve needle cooperates with the valve seat to open and close the outer row of injection openings so that either fuel from the pressure chamber is injected into the combustion chamber via these injection openings or the connection from the pressure chamber to the injection openings is closed.

The outer valve needle has a longitudinal bore containing a longitudinally sliding inner valve needle. The combustion chamber end of the inner valve needle likewise cooperates with the valve seat to open and close the inner row of injection openings so that when the outer valve needle is open, the inner valve needle can control the opening of the inner row of injection openings in such a way that depending on the actuation of the valve needles, fuel is injected into the combustion chamber either via only one row of injection openings or via both of them.

The inner valve needle is guided in the longitudinal bore of the outer valve needle in two guide sections. The first guide section is oriented further away from the combustion chamber than the second guide section so that an annular gap is formed between the guide sections, delimited by the inner valve needle and the wall of the longitudinal bore. The two guide sections serve to prevent the inner valve needle from jamming and simultaneously provide a precise guidance in the longitudinal bore. The inner valve needle is opened in opposition to a closing force, through exertion of hydraulic pressure on a valve sealing surface located at the end of the inner valve needle oriented toward the combustion chamber. After the outer valve needle has lifted away from the valve seat, this valve sealing surface of the inner valve needle is acted on by the fuel pressure of the pressure chamber, thus generating an opening force on the inner valve needle, causing it in turn to lift away from the valve seat and open the inner row of injection openings.

In order to achieve a shaping of the injection curve, i.e. to open only the outer row of injection openings at the beginning of the injection and to open the inner row of injection openings as well only after a certain amount of time, it is only permissible for the inner valve to open after a certain delay. In the previously known fuel injection valve, however, this is only the case to a limited degree since the moment the outer valve needle lifts away from the valve seat, the valve sealing surface is immediately subjected to the fuel pressure of the pressure chamber and starts to move right away. To achieve an even more delayed opening of the inner valve needle, it was necessary to deliberately control the closing force, a strategy that is very complex and therefore as a rule, too expensive.

### ADVANTAGES OF THE INVENTION

The fuel injection valve according to the present invention, with the characterizing features of claim 1, has the advantage over the prior art that through the use of structurally simple means, the inner valve needle lifts away from the valve seat in a delayed fashion in relation to the outer valve needle. To this end, the annular chamber between the inner valve needle and the wall of the longitudinal bore can be connected to the pressure chamber via a throttle connection, the diameter of the first guide section being greater than the diameter of the second guide section. This assures that the pressure in the annular chamber produces a resulting force on the inner valve needle, oriented away from the valve seat. The inner valve needle opens only when the hydraulic forces in the annular chamber work in concert with the hydraulic force on a corresponding surface at the combustion chamber end of the inner valve needle.

Advantageous modifications of the subject of the invention are possible by means of the dependent claims.

In a first advantageous modification, the throttle connection is constituted by the annular gap remaining between the second guide section of the inner valve needle and the wall of the longitudinal bore. This also has the advantage that the throttle connection is connected to the pressure chamber only when the outer valve needle lifts away from the valve seat so that only then does an influx of fuel from the pressure chamber into the annular chamber occur, accompanied by an attendant increase in the pressure in the annular chamber. Preferably, the annular gap remaining between the second guide section and the longitudinal bore here has a lower flow resistance than the annular gap between the first guide section and the wall of the longitudinal bore so that the influx of fuel leads to a rapid pressure increase in the annular chamber. It is also particularly advantageous if the annular chamber is connected to a leakage chamber via the annular gap between the first guide section and the wall of the longitudinal bore so that the fuel pressure in the annular chamber decreases during the injection pauses when both of the valve needles contact the valve seat again.

In another advantageous embodiment, a lateral bore in the outer valve needle constitutes the throttle connection of the annular chamber to the pressure chamber. This embodiment is suitable when a high fuel pressure does not prevail in the pressure chamber on a continuous basis, but only when an injection of fuel is to take place. A throttle connection of this kind can be easily produced in the form of a precisely dimensioned annular gap between the second guide section and the longitudinal bore of the outer valve needle.

In another advantageous embodiment, ground surfaces are provided on the sides of the second guide section. This makes it possible to deliberately set the flow resistance along the second guide section in order to assure the desired flow resistance for the influx of the fuel from the pressure chamber into the annular chamber.

### DRAWINGS

Various exemplary embodiments of the fuel injection valve according to the present invention are shown in the drawings.

FIG. 1 shows a longitudinal section through a fuel injection valve according to the present invention,

FIG. 2 is an enlarged depiction in the region of the valve seat from FIG. 1,

FIG. 3 is an enlargement of FIG. 1 in the region of the first guide section of the inner valve needle,

FIG. 4 shows the same detail as FIG. 2 of another exemplary embodiment, and

FIG. 5 shows a longitudinal section through another fuel injection valve according to the present invention.

### DESCRIPTION OF THE EXEMPLARY EMBODIMENTS

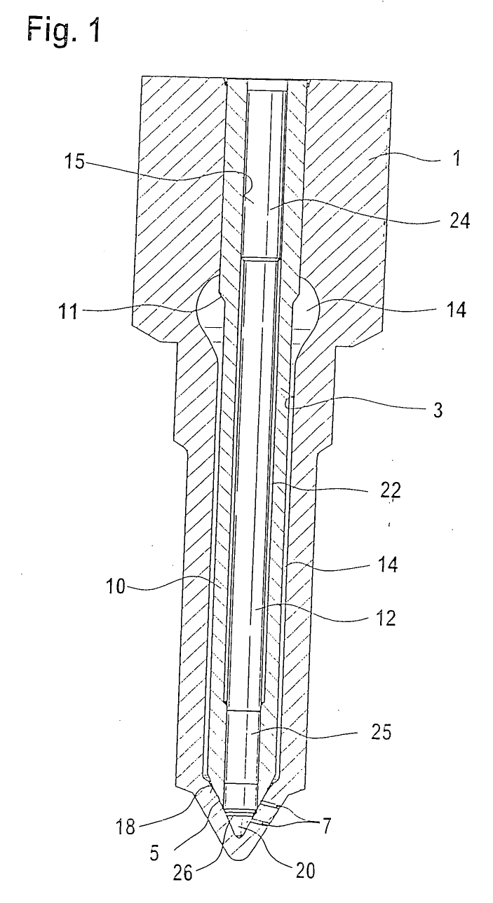

FIG. 1 shows a longitudinal section through a fuel injection valve according to the present invention. The valve body 1 contains a bore 3 whose end oriented toward the combustion chamber is provided with a conical valve seat 5 that delimits the bore 3. The valve seat 5 has at least 2 injection openings 7 leading from it, which, in the installed position of the fuel injection valve, feed into the combustion chamber of the engine. The bore 3 contains an outer valve needle 10 whose end oriented toward the combustion chamber is provided with a valve sealing surface 18 that is likewise conical, with which the outer valve needle 10 cooperates with the valve seat 5. Between the wall of the bore 3 and the outer valve needle 10, whose section oriented away from the combustion chamber is guided in the bore 5 in a sealed fashion, there is a pressure chamber 14 that widens out radially adjacent to the guided section of the outer valve needle 10. The pressure chamber 14 extends in the direction of the valve seat 5 until it reaches the valve seat 5. In the region of its radial expansion, the pressure chamber 14 can be filled with highly pressurized fuel via a supply conduit that extends inside the valve body 1 and is not shown in the drawing. At the level of the radial expansion of the pressure chamber 14, the outer valve needle 10, whose diameter decreases from the guided section toward the valve seat 5, is provided with a pressure shoulder 11 on which the fuel pressure in the pressure chamber 14 exerts an opening force on the outer valve needle 10 in the direction oriented away from the valve seat 5.

Extending over its entire length, the outer valve needle 10 is provided with a longitudinal bore 15 that contains a longitudinally sliding, likewise piston-shaped inner valve needle 12. At its end oriented toward the combustion chamber, the inner valve needle 12 has a valve sealing surface 20 that cooperates with the valve seat 5. The inner valve needle 12 has a first guide section 24 and a second guide section 25 oriented toward the valve 5, both of which guide the inner valve needle 12 in the longitudinal bore 15. Between the guide sections 24, 25, delimited by the inner valve needle 12 and the wall of the longitudinal bore 15, there is an annular chamber 22 that is filled with fuel. At its combustion chamber end, the inner valve needle 12 has a pressure surface 26 that is acted on by the fuel of the pressure chamber 14 when the outer valve needle 10 has lifted away from the valve seat 5.

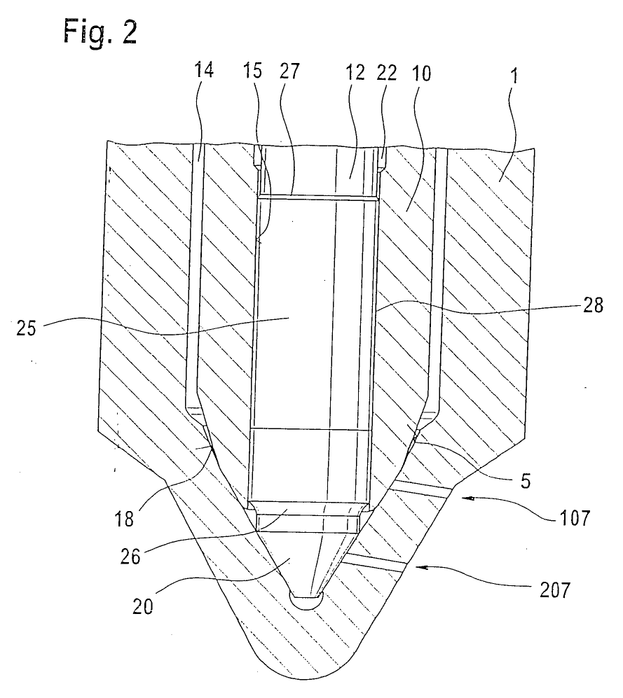

FIG. 2 shows the cooperation of the outer valve needle 10 and inner valve needle 12 with the valve seat 5 in greater detail. The injection openings 7 are arranged in an outer row of injection openings 107 and an inner row of injection openings 207 located closer to the combustion chamber. The rows of injection openings 107, 207 each include a number of injection openings 7 that are distributed around the circumference of the valve body 1. When the fuel injection valve is closed, the respective sealing surfaces 18, 20 of the outer valve needle 10 and the inner valve needle 12 rest against the valve seat 5, thus closing both the outer row of injection openings 107 and the inner row of injection openings 207. A device not shown in the drawing acts on the outer valve needle 10 and the inner valve needle 12 with a closing force acting in the direction of the valve seat 5, thus pressing both of the valve needles 10, 12 against the valve seat 5. For example, the devices for generating the closing force are springs that each act on a respective valve needle 10, 12. If only the outer valve needle 10 lifts away from the valve seat 5, then fuel from the pressure chamber 14 can travel to the outer row of injection openings 107 and is injected from there into the combustion chamber of the engine. If the inner valve needle 12 also moves away from the valve seat 5, then it opens the inner row of injection openings 207 and the fuel is injected through both the outer row of injection openings 107 and the inner row of injection openings 207.

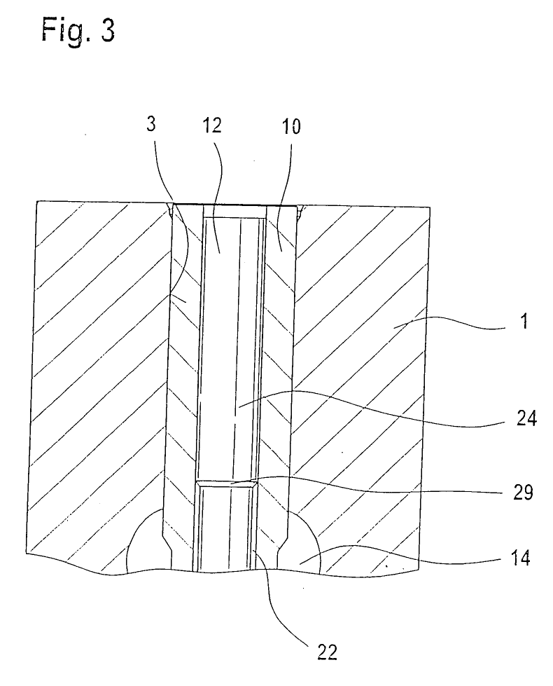

FIG. 3 shows an enlargement from FIG. 1 in the region of the first guide section 24 of the inner valve needle 12. Like the second guide section 25, the first guide section 24 is constituted by a radial expansion of the inner valve needle 12. The diameter of the first guide section 24 here is greater than the diameter of the second guide section 25, which is possible, for example, due to the provision of a diametrically stepped longitudinal bore 25. The annular shoulder 29 formed at the combustion chamber end of the first guide section 24 thus has a greater effective hydraulic area acting in the longitudinal direction of the inner valve needle 12 than the shoulder 27 on the second guide section 25. As a result of this, the fuel pressure in the annular chamber 22 generates a resulting hydraulic force on the inner valve needle 12, oriented away from the valve seat 5. The annular gap formed between the first guide section 24 of the inner valve needle 12 and the wall of the longitudinal bore 15 connects the annular chamber 22 to a leakage chamber not shown in the drawing, which contains a continuous low fuel pressure. This assures that a high fuel pressure in the annular chamber 22 will, after a certain time, be discharged via this annular gap, thus assuming the low fuel pressure in the leakage chamber.

The fuel injection valve functions as follows: In operating mode, in which high fuel pressure continuously prevails in the pressure chamber 14, the injection of fuel is initiated by reducing the closing force on the outer valve needle 10. As a result, the hydraulic force acting on the pressure shoulder 11 of the outer valve needle 10 and on parts of the valve sealing surface 18 preponderates so that the outer valve needle 10 lifts away from the valve seat 5 and opens the outer row of injection openings 107 in the manner described above. As a result, fuel pressure now acts on the pressure surface 26 on the inner valve needle 12, but is not sufficient to permit the inner valve needle 12 to lift away from the valve seat 5 counter to the closing force acting on it. By means of the annular gap 28 formed between the second guide section 25 and the wall of the longitudinal bore 15, which constitutes a throttle connection, fuel only travels into the annular chamber 22 gradually, thus allowing the fuel pressure in it to rise. If the fuel pressure in the annular chamber 22 is sufficient, then the resulting additional hydraulic force on the annular shoulder 29 in the first guide section 24 exerts an additional opening force on the inner valve needle 12, as a result of which these hydraulic forces finally overcome the closing force acting on the inner valve needle 12, whereupon the inner valve needle 12 lifts away from the valve seat 5 and opens the inner row of injection openings 207. This achieves a successive opening of the outer valve needle 10 followed by the inner valve needle 12, without having to control the closing force on the inner valve needle 12. If the injection is to be terminated, then the closing force on the outer valve needle 10 is increased, causing it to slide back into its closed position, i.e. in contact with the valve seat 5. The pressure in the annular chamber 22 is discharged into the leakage chamber via the annular gap between the first guide section 24 and the wall of the bore 15 so that after a certain time, the closing force on the inner valve needle 12 overcomes the opening forces and the inner valve needle 12 likewise slides back into its closed position. If the closing force on the inner valve needle 12 is also variable and is increased or decreased at the same time as the closing force on the outer valve needle 10, then it is also possible for the inner valve needle 12 to close before the outer valve needle 10. In injection valves of the kind used for high-speed internal combustion engines, the entire injection process takes place within a few milliseconds.

When the fuel injection valve is in the operating mode in which the pressure in the pressure chamber 14 is not always constant, but is only increased when an injection is to take place, the fuel injection valve operates in the same manner, but the closing force on the outer valve needle 10 remains constant. The increasing fuel pressure in the pressure chamber 14 increases the opening force on the pressure shoulder 11 and the valve sealing surface 18 until this opening force is greater than the closing force and the outer valve needle 10 opens. The opening of the inner valve needle 12 occurs in the above-described manner as soon as its connection to the pressure chamber 14 is established by the opened outer valve needle 10. To terminate the injection, the pressure chamber 14 is depressurized, thus reducing the hydraulic pressure on the valve needles 10, 12. Depending on the magnitude of the closing forces, either the inner valve needle 12 or the outer valve needle 10 returns to the closed position first.

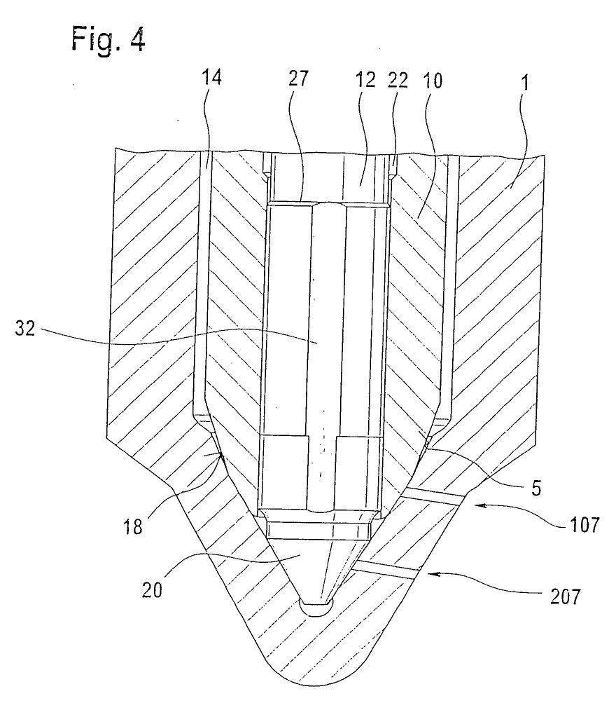

FIG. 4 shows the same detail as FIG. 2 of another exemplary embodiment. In order for the fuel injection valve to function as desired, it is crucial for the fuel to flow into the annular chamber 22 at the rate required to produce the pressure increase within the desired time. If the annular gap remaining between the second guide section 25 and the wall of the longitudinal bore 15, which is very narrow—preferably 2-3 mm, is insufficient for this, then it is possible to provide the second guide section 25 with ground surfaces 32 that permit an expansion of the throttle connection between the annular chamber 22 and the pressure chamber 14. The depth of the ground surfaces 32 at this point can be used to set the flow resistance to any desired level. The opening speed is also influenced by the ratio of the diameters of the first guide section 24 and second guide section 25: if the inner valve needle 12 moves away from the valve seat 5 while the outer valve needle 10 remains stationary, then the volume of the annular chamber 22 increases. This counteracts the pressure increase due to the fuel flowing into the annular chamber 22 via the annular gap 28, thus reducing the opening speed of the inner valve needle 12.

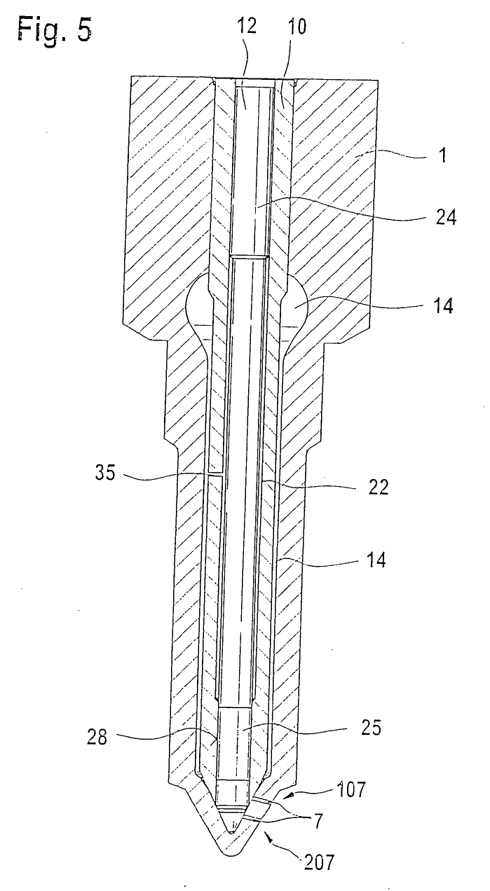

If the fuel injection valve is operated so that the pressure in the pressure chamber 14 is increased only to execute an injection, then it is also possible to embody the fuel injection valve as depicted in FIG. 5. The design of this fuel injection valve largely corresponds to the one shown in FIG. 1, but the throttle connection from the annular chamber 22 to the pressure chamber 14 is constituted by a throttle bore 35 that is provided in the outer valve needle 10 and connects the pressure chamber 14 to the annular chamber 22. A suitable dimensioning of the throttle bore 35 that constitutes the throttle connection in this case makes it possible to control the pressure increase in the annular chamber 22 so that a successive opening of the outer valve needle 10 and the inner valve needle 12 occurs in the above-described manner. Instead of only a single throttle bore 35, it is also possible to provide several throttle bores 35 in the outer valve needle 10 to achieve a uniform pressure increase in the annular chamber 22 and thus prevent pressure oscillations.

In the exemplary embodiment shown in FIG. 5, it is also possible to use the annular gap 28 in addition to the throttle bore 35 to set the opening dynamics of the valve needles 10, 12. As a result of the pressure increase in the pressure chamber 14, the pressure in the annular chamber 22 also increases via the throttle bore 35. On the one hand, this generates an opening force on the inner valve needle 12 and on the other hand, it generates a closing force that acts on the outer valve needle 10 in the direction oriented toward the valve seat 5 due to difference in diameter between the first guide section 24 and the second guide section 25. This increases the opening pressure on the outer valve needle 10, which consequently lifts away from the valve seat 5 once a higher pressure has been reached in the pressure chamber 14. After the outer valve needle 10 opens, the pressure in the annular chamber 22 then also increases due to the influx of fuel via the annular gap 28, until the hydraulic forces are sufficient to open the inner valve needle 12. The pressure increase in the annular chamber 22 and therefore the opening dynamics of the valve needles 10, 12 here depend on the balancing of the cross section of the throttle bore 35 with that of the annular gap 28.

1-9. (canceled)

10. A fuel injection valve for internal combustion engines, comprising
a valve body (1) containing a bore (3) whose combustion chamber end is delimited by a valve seat (5) from which at least two injection openings (7) lead;
an outer valve needle (10) contained in the bore (3) in a longitudinally sliding fashion and having an end oriented toward the combustion chamber that opens and closes at least one injection opening (7);
a pressure chamber (14) formed between the outer valve needle (10) and the wall of the bore (3), which pressure chamber can be filled with fuel;
a longitudinal bore (15) in the outer valve needle (10);
a longitudinally sliding inner valve needle (12) contained in the longitudinal bore (15) and whose end oriented toward the combustion chamber opens and closes at least one injection opening (7); the inner valve needle (12) including a first guide section (24) and a second guide section (25) located closer to the valve than the first one, the first and second guide sections (24; 25) guiding the inner guide needle (12) in the longitudinal bore (15);
an annular chamber (22) formed between the guide sections (24, 25) which annular chamber (22) is delimited by the inner valve needle (12) and the wall of the longitudinal bore (15);
a throttle connection (28; 35) connecting the annular chamber (22) to the pressure chamber (14); and
the diameter of the first guide section (24) being greater than the diameter of the second guide section (25).

11. The fuel injection valve according to claim 10, wherein the throttle connection (28; 35) is constituted by the annular gap (28) remaining between the second guide section (25) of the inner valve needle (12) and the wall of the longitudinal bore (15).

12. The fuel injection valve according to claim 11, wherein the annular gap remaining between the wall of the longitudinal bore (15) and the first guide section (24) has a lower flow resistance than the annular gap (28) remaining between the second guide section (25) and the wall of the longitudinal bore (15).

13. The fuel injection valve according to claim 10, further comprising ground surfaces (32) are provided on the sides of the second guide section (25).

14. The fuel injection valve according to claim 10, wherein the outer valve needle (10) opens the throttle connection (28; 35).

15. The fuel injection valve according to claim 10, wherein the guide sections (24; 25) are each constituted by a diametrical expansion of the inner valve needle (12).

16. The fuel injection valve according to claim 10, wherein the throttle connection (28; 35) is constituted by a throttle bore (35) that is contained in the outer valve needle (10) and connects the annular chamber (22) to the pressure chamber (14).

17. The fuel injection valve according to claim 14, wherein the diameter of the longitudinal bore (15) is embodied as stepped.

18. The fuel injection valve according to claim 10, further comprising an annular gap formed between the first guide section (24) and the wall of the longitudinal bore (15) that is capable of connecting the annular chamber (22) to a leakage chamber.
